(19) United States
(12) Patent Application Publication
(10) Pub. No.: US 2026/0286173 A1
(43) Pub. Date: Sep. 24, 2026

(54) COATINGS COMPRISING NAD POLYMERS WITH VOLATILE SILOXANE

(71) Applicant: SWIMC LLC, Cleveland, OH (US)

(72) Inventors: James M. Cameron, Valley City, OH (US); Dun Zhang, Moreland Hills, OH (US)

(21) Appl. No.: 18/867,549

(22) PCT Filed: May 24, 2023
(86) PCT No.: PCT/US2023/023304

§ 371 Date: Nov. 20, 2024

Related U.S. Application Data
(60) Provisional application No. 63/365,214, filed on May 24, 2022.

(51) Int. Cl. C09D 167/06; C09D 7/63; C09D 15/00

(52) U.S. Cl. CPC C09D 167/06; C09D 7/63; C09D 15/00

(57) ABSTRACT

The present application relates to a coating composition comprising at least one non-aqueous dispersion (NAD) acrylic alkyd polymer, at least one non-aqueous dispersion (NAD) acrylic alkyd polymer, or combinations thereof and at least one siloxane. At least one siloxane may be methyl siloxane. Also described is a method of preparing the coating composition and an article containing the coating composition described herein.

### FIELD

The present disclosure relates generally to a coating composition comprising at least one non-aqueous dispersion (NAD) acrylic alkyd polymer, at least one non-aqueous dispersion (NAD) acrylic polymer, or combinations thereof and at least one siloxane. A method of preparing the coating and an article containing the coating are also disclosed.

### BACKGROUND

More recently, clearcoats, stains, and pigmented coatings, including both waterborne and solvent borne coatings, have been used in numerous applications, including but not limited to applications in general industrial, building materials, homes and businesses, wood, composites, and other goods that may be coated. However, these types of coatings often struggle to meet the needed performance properties due to requirements for coatings with lower or zero volatile organic compounds (VOC's). Further, environmental regulations may limit the ability to achieve lower or zero VOC's, especially with certain solvents losing their exempt status. Additionally, customers using the products with lower or zero VOC's may still prefer older products that do not adhere to the current environmental demands. Achieving VOC regulatory compliance (typically <250 g/l of VOC's) along with the performance properties has been a well-known industry challenge.

For customers with a new deck made from wood, composite, or combinations of both, a coating may be used to protect the substrate. These coatings may include either solvent-based stains or water-based stains. Solvent-based stains are often easier to apply over wood than water-based stains. Solvent-based stains may penetrate the wood, reducing lap marks and future peeling. In particular, low solids stains may penetrate into weathered wood substrates. However, stains that have a high solids content, specifically those greater than about 75% non-volatile matter (NVM), may not penetrate into weathered wood substrates as well as low solids stains and may remain on the surface of the substrate. However, solvent-based stains contain higher VOC's and fail by erosion in which the dry film coating breaks down slowly over time after weathering. Further, they are more prone to act as a food source for mold, mildew, and algae, especially with solvent-based stains containing linseed oil. For example, long oil alkyd resin has been used for high solids wood stains. Additionally, product performance of coatings containing long oil alkyd resins suffers from slow dry times and tackiness, especially with solvent-based stains containing a long oil alkyd resin with mineral oil. In order to overcome these challenges, water reducible alkyd technology had been developed to achieve low VOC target, but the high polarity of the alkyd resin reduces its performance properties, including weatherability.

Alternatively, water-based acrylic stains generally provide improved UV resistance and color retention. Although water-based acrylic stains have improved drying time, they are more difficult to apply. Further, water-based acrylic stains may not penetrate into weathered wood substrates as well as solvent-based stains and may remain on the surface of the substrate. Since they have more difficulty in penetrating wood, they also have a potential for peeling if the coating is overapplied due to loss of adhesion to the wood substrate. Water-based acrylic stains may also be difficult to recoat if the coating has inconsistently peeled.

Further, lower VOC's in a solvent-borne coating typically result in thicker coatings and provide a film build which may not be desirable. Additionally, coatings with higher VOC's and waterborne coatings may have difficulty penetrating into a substrate like wood. Ease of application may also be affected by VOC changes within the coating as well as lapping.

Manufacturers and consumers have increasingly demanded for these particular performance requirements for such coatings, especially wood coatings. Manufacturers and consumers are continually looking for coatings that exhibit these performance requirements properties such as weatherability, wear resistance, adhesion, application, and mold, mildew, and algae resistance while having decreased VOC's and without sacrificing other performance and application properties. In view of these challenges with many conventional coatings, the need therefore remains for improved coatings having a binder that can provide weatherability, wear resistance, adhesion, lower VOC's, and other improved properties as well as other advantages.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

A coating and methods of preparing are shown and described. The coating composition may comprise at least one non-aqueous dispersion (NAD) acrylic alkyd polymer, at least one non-aqueous dispersion (NAD) acrylic polymer, or combinations thereof and at least one siloxane.

Also described is a method of preparing the coating composition comprising at least one non-aqueous dispersion (NAD) acrylic alkyd polymer and at least one siloxane. An article containing the coating composition comprising at least one non-aqueous dispersion (NAD) acrylic alkyd polymer, at least one non-aqueous dispersion (NAD) acrylic polymer, or combinations thereof and at least one siloxane is also described.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to coatings that provide advantageous improvements over current coatings. It has been discovered that the use of a particular coating composition comprising at least one non-aqueous dispersion (NAD) acrylic alkyd polymer, at least one non-aqueous dispersion (NAD) acrylic polymer, or combinations thereof and at least one siloxane can surprisingly lead to improved performance properties when used in a coating, namely dry time and tackiness, application, while having decreased VOC's and without sacrificing other performance properties such as weatherability, wear resistance, adhesion, and mold, mildew, and algae resistance as well as other advantages. In particular, the coating composition comprising at least one non-aqueous dispersion (NAD) acrylic alkyd polymer, at least one non-aqueous dispersion (NAD) acrylic polymer, or combinations thereof and at least one siloxane may have improved properties with the addition of both reactive and non-reactive diluents. Additionally, siloxane may reduce the film build for higher solids systems in which the NAD's have an NVM of at least 70%. siloxane may reduce the film build for higher solids systems in which the NAD's have an NVM of at least 65%. In one embodiment, siloxane may reduce the film build for higher solids systems in which the NAD's have an NVM of at least 70%.

Non-aqueous dispersions (NAD's) are well known in the art and typically consist of dispersions of addition polymers in a relatively non-polar non-aqueous liquid. High solids NAD's, specifically those of at least 70% NVM, have lower VOC's of less than 250 g/l, which provide stability, filterability, low grit, acceptable viscosity, and tack-free and dry times when formulated into coatings.

The process for producing the NAD's comprising an alkyd acrylic polymer comprises using at least one alkyd as the dispersing medium for the polymerization of monomers which are predominantly insoluble in the alkyd medium. In some embodiments, the alkyd can be produced according to any of the traditional processes for the production of alkyds which are readily available from the art or the alkyd can be produced such as fatty acid esterification or alcoholysis of a drying oil with later reaction with a di- or tri-basic acid. In other embodiments, the alkyd may be produced in a two-step process wherein the first step comprises the acidolysis reaction of a triglyceride oil with a trifunctional carboxylic acid or a trifunctional anhydride, and the second step comprises reacting the product of the first step with a multifunctional alcohol. To form the alkyd, the triglyceride oil is first reacted via an acidolysis reaction with a trifunctional carboxylic acid such as trimelletic acid, trimesic acid, 1,3,5-pentane tricarboxylic acid, citric acid or a trifunctional anhydride such as trimelletic anhydride, pyromelletic anhydride, or mixtures of such acids and/or anhydrides. The intermediate from the acidolysis step is further reacted with a trifunctional alcohol selected from the group comprising trimethylol propane, trimethylol ethane, glycerine, tris hydroxyethyl isocyanurate, or combinations thereof, either alone or in combination with a difunctional alcohol selected from the group comprising ethylene glycol, propylene glycol, cyclohexane dimethanol, or combinations thereof. Additionally, dimethylol propionic acid can be used in combination with the trifunctional alcohol. Trifunctional alcohols are particularly preferred due to the degree of branching they allow. Difunctional alcohols, if used, are preferably used as a minor component in combination with trifunctional alcohols. Depending on the desired molecular weight and viscosity, a portion of monofunctional alcohol, or monobasic acid such as soya fatty acid, linseed oil fatty acid or crotonic acid, up to about 20% by weight of the total alkyd can be added with the multifunctional alcohol to control molecular weight and act as a chain stopper. The triglyceride oil used in the formation of the alkyd can be selected from the group comprising linseed oil, soya oil, coconut oil, cottonseed oil, peanut oil, canola oil, corn oil, safflower oil, sunflower oil, dehydrated castor oil, fish oil, perilla, lard, walnut oil, tung oil, or combinations thereof. Particularly preferred are those oils containing unsaturation in the glyceride chains. Particularly preferred are soya oil, dehydrated castor oil and linseed oil.

In some embodiments, the alkyd may be a modified alkyd. The alkyd may be either alone or in combination with some minor amount of hydrocarbon, aromatic, polar, ketone, ester, or alcohol solvent, or in combination with other minor amounts of other alkyd, modified-alkyd, or hydrocarbon dispersing media.

In many embodiments, the molecular weight, M_{z}, of the resulting alkyd should be greater than or equal to about 20,000. In some embodiments, the oil length should be between about 65% and 85%. In further embodiments, the hydroxyl number should be less than 60, preferably less than 45.

When preparing non-aqueous dispersions using the novel alkyd above, the monomers should be selected from monomers which would produce a polymer via the free radical addition reaction mechanism which is predominantly insoluble in the alkyd medium. In many embodiments, at least one of the monomers contain hydroxy functionality. In many embodiments, between about 5% and 45% by weight of the monomer charge comprises hydroxy functional monomers. Suitable monomers can be selected from the group comprising acrylonitrile, methacrylonitrile, acrylic acid, methacrylic acid, and esters of these acids, especially hydroxy ethyl acrylate and methacrylate, hydroxy propyl acrylate and methacrylate, methyl acrylate and methacrylate, ethyl acrylate and methacrylate, butyl acrylate and methacrylate, lauryl acrylate and methacrylate, and the like, trimethylol propane triacrylate and trimethacrylate, hexanediol diacrylate, acrylamide, and methacrylamide. Other monomers are also contemplated. In addition to pure monomers, preformed polymers and polymeric intermediates may be included in the reaction charge in some embodiments.

For NAD's comprising an acrylic polymer, the monomers should be selected from monomers which would produce a polymer via the free radical addition reaction mechanism which is in an insoluble medium. Suitable monomers can be selected from the group comprising acrylonitrile, methacrylonitrile, acrylic acid, methacrylic acid, and esters of these acids, especially hydroxy ethyl acrylate and methacrylate, hydroxy propyl acrylate and methacrylate, methyl acrylate and methacrylate, ethyl acrylate and methacrylate, butyl acrylate and methacrylate, lauryl acrylate and methacrylate, and the like, trimethylol propane triacrylate and trimethacrylate, hexanediol diacrylate, acrylamide, and methacrylamide. Other monomers are also contemplated. In addition to pure monomers, preformed polymers and polymeric intermediates may be included in the reaction charge in some embodiments.

In many embodiments, about 10% to 99.5% by weight of the coating composition comprises the at least one non-aqueous dispersion (NAD) acrylic alkyd polymer, at least one non-aqueous dispersion (NAD) acrylic polymer, or combinations thereof. In some embodiments, at least one non-aqueous dispersion (NAD) acrylic alkyd polymer, at least one non-aqueous dispersion (NAD) acrylic polymer, or combinations thereof of the coating composition can, for example, range (by weight) from about 10% to about 95%, from about 10% to about 90%, from about 10% to about 85%, from about 10% to about 80%, from about 10% to about 75%, from about 10% to about 70%, from about 10% to about 65%, from about 10% to about 60%, from about 10% to about 55%, from about 10% to about 50%, from about 15% to about 95%, from about 15% to about 90%, from about 15% to about 85%, from about 15% to about 80%, from about 15% to about 75%, from about 15% to about 70%, from about 15% to about 65%, from about 15% to about 60%, from about 15% to about 55%, from about 15% to about 50%, from about 20% to about 95%, from about 20% to about 90%, from about 20% to about 85%, from about 20% to about 80%, from about 20% to about 75%, from about 20% to about 70%, from about 20% to about 65%, from about 20% to about 60%, from about 20% to about 55%, from about 20% to about 50%, from about 25% to about 95%, from about 25% to about 90%, from about 25% to about 85%, from about 25% to about 80%, from about 25% to about 75%, from about 25% to about 70%, from about 25% to about 65%, from about 25% to about 60%, from about 25% to about 55%, and from about 25% to about 50%. Other ranges are also contemplated.

In many embodiments, about 10% to 60% by weight of the coating composition comprises the at least one non-aqueous dispersion (NAD) acrylic alkyd polymer, at least one non-aqueous dispersion (NAD) acrylic polymer, or combinations thereof if the VOC's of the coating composition are 250 g/l or less as measured by ASTM D3960. In some embodiments, at least one non-aqueous dispersion (NAD) acrylic alkyd polymer of the coating composition can, for example, range (by weight) from about 10% to about 95% if the VOC's of the coating composition are 250 g/l or less as measured by ASTM D3960, from about 10% to about 55%, from about 10% to about 50%, from about 10% to about 45%, from about 10% to about 40%, from about 10% to about 35%, from about 10% to about 30%, from about 10% to about 25%, from about 10% to about 20%, from about 15% to about 55%, from about 15% to about 50%, from about 15% to about 45%, from about 15% to about 40%, from about 15% to about 35%, from about 15% to about 30%, from about 15% to about 25%, from about 20% to about 55%, from about 20% to about 50%, from about 20% to about 45%, from about 20% to about 40%, from about 20% to about 35%, from about 20% to about 30%, from about 25% to about 55%, from about 25% to about 50%, from about 25% to about 45%, from about 25% to about 40%, from about 25% to about 35%, from about 30% to about 55%, from about 30% to about 50%, from about 30% to about 45%, from about 30% to about 40%, and from about 35% to about 55%. Other ranges are also contemplated.

In many embodiments, the VOC's of the coating composition are 500 g/l or less as measured by ASTM D3960. In some embodiments, the coating composition described herein has a Volatile Organic Compound (VOC) as measured by ASTM D3960 of less than 250 g/l. In other embodiments, the coating composition described herein can have Volatile Organic Compound (VOC) as measured by ASTM D3960 of less than 450 g/l, less than 400 g/l, less than 350 g/l, less than 300 g/l, less than 275 g/l, less than 225 g/l, less than 200 g/l, less than 175 g/l, less than 150 g/l, less than 125 g/l, less than 100 g/l, less than 75 g/l, less than 50 g/l, and less than 25 g/l. Lower and higher levels of VOC's are also contemplated.

In many embodiments, the coating composition has a volatile organic compound content of less than about 250 g/L according to EPA M24. In other embodiments, the coating composition described herein can have Volatile Organic Compound (VOC) as measured by EPA M24 of less than 225 g/l, less than 200 g/l, less than 175 g/l, less than 150 g/l, less than 125 g/l, less than 100 g/l, less than 75 g/l, less than 50 g/l, and less than 25 g/l. Lower and higher levels of VOC's are also contemplated.

In many embodiments, the non-aqueous dispersion (NAD) acrylic alkyd polymer, at least one non-aqueous dispersion (NAD) acrylic polymer, or combinations thereof comprises at least one acrylic has a glass transition temperature (Tg) of 20° C. to 60° C. as measured by Differential Scanning calorimetry (DSC) using ASTM D6604-00. In other embodiments, the glass transition temperature (Tg) as measured by Differential Scanning calorimetry (DSC) using ASTM D6604-00 for the non-aqueous dispersion (NAD) acrylic alkyd polymer comprising at least one acrylic can, for example, range from 20° C. to 55° C., 20° C. to 50° C., 20° C. to 45° C., 25° C. to 60° C., 25° C. to 55° C., 25° C. to 50° C., 25° C. to 45° C., 30° C. to 60° C., 30° C. to 55° C., 30° C. to 50° C., 35° C. to 60° C., 35° C. to 55° C., and 40° C. to 60° C.

In many embodiments, about 0.5% to about 20% by weight of the coating composition comprises the at least one siloxane. In some embodiments, at least one siloxane of the coating composition can, for example, range (by weight) from about 1% to 20%, from about 1% to 18%, from about 1% to 15%, from about 1% to 12%, from about 1% to 10%, from about 2% to 20%, from about 2% to 18%, from about 2% to 15%, from about 2% to 12%, from about 2% to 10%, from about 3% to 20%, from about 3% to 15%, from about 3% to 12%, from about 3% to 10%, from about 5% to 20%, from about 5% to 18%, from about 5% to 15%, from about 5% to 12%, from about 7% to 20%, from about 7% to 18%, from about 7% to 15%, from about 7% to 12%, from about 10% to 20%, from about 10% to 18%, from about 10% to 15%, from about 12% to 20%, and from about 12% to 18%.

In many embodiments, at least one siloxane is cyclic, linear, or combinations thereof. In some embodiments, the at least one siloxane is methyl siloxane. In one embodiment, at least one siloxane is a volatile methyl siloxane (VMS). In some embodiments, the methyl siloxane comprises cyclotetrasiloxane, cyclopentasiloxane cyclohexasiloxane, octamethylcyclotetrasiloxane, decamethylcyclopentasiloxane, dodecamethylcyclohexasiloxane, trisiloxane, dimethicone, or combinations thereof. Other modified siloxanes are also contemplated.

In many embodiments, at least one siloxane is a siloxane fluid. In many embodiments, at least one siloxane is a volatile methyl siloxane (also referred to as VMS). In certain embodiments, the VMS has a flash point of at least 100° F. (37° C.) as measured by ASTM D93. In one embodiment, the siloxane has Structure 1 below:

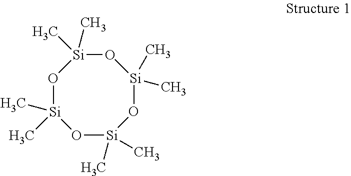

In some embodiments, at least one siloxane is an alkyl methyl siloxane. In one embodiment, the siloxane has the Structure 2 below:

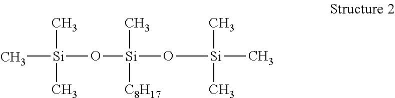

In one embodiment, the coating composition described herein further comprises at least one hyper-branched alkyd polymer. In many embodiments, many hyper-branched alkyd polymers commonly used are contemplated. In some embodiments, the hyper-branch alkyd polymers do not significantly increase the viscosity of the coating composition. The amounts of oil, acid and alcohol used should be such that the resulting alkyd polymer may a higher degree of branching and an oil length of between about 65% and 85%, and a hydroxyl number less than 80. In some embodiments, the hydroxyl number is less than 70. In some embodiments, the hydroxyl number is less than 60. In some embodiments, the hydroxyl number is less than 50. [symbol] n some embodiments, the hydroxyl number is less than 45. [symbol] n some embodiments, about 0% to about 20% by weight of the coating composition comprises the at least one hyper-branched alkyd polymer. In some embodiments, at least one hyper-branched alkyd polymer of the coating composition can, for example, range (by weight) from about 0.5% to 20%, from about 0.5% to 18%, from about 0.5% to 15%, from about 0.5% to 12%, from about 0.5% to 10%, from about 1% to 20%, from about 1% to 18%, from about 1% to 15%, from about 1% to 12%, from about 1% to 10%, from about 0.5% to 20%, from about 2% to 20%, from about 2% to 18%, from about 2% to 15%, from about 2% to 12%, from about 2% to 10%, from about 3% to 20%, from about 3% to 15%, from about 3% to 12%, from about 3% to 10%, from about 5% to 20%, from about 5% to 18%, from about 5% to 15%, from about 5% to 12%, from about 7% to 20%, from about 7% to 18%, from about 7% to 15%, from about 7% to 12%, from about 10% to 20%, from about 10% to 18%, from about 10% to 15%, from about 12% to 20%, and from about 12% to 18%. Other ranges are also contemplated.

In some embodiments where the non-aqueous dispersion (NAD) acrylic alkyd polymer is in the coating composition, at least one hyper-branched alkyd polymer is obtained by reacting at least one fatty acid with at least one hyper-branched polyol. In other embodiments, at least one hyper-branched polyol comprises at least one polyester.

In one embodiment where the non-aqueous dispersion (NAD) acrylic alkyd polymer is in the coating composition, the coating composition described herein further comprises at least one alkyd resin. In some embodiments, about 10% to about 40% by weight of the coating composition comprises the at least one alkyd resin.

Additionally, various additives as used herein refer to a general category of components or other raw materials that may be added to the compositions herein to promote various properties. In many embodiments, the coating composition further comprises at least one reactive diluent, at least one non-reactive diluent, at least one solvent, at least one drier, at least one colorant, at least one pigment, at least one dispersant, at least one surfactant, at least one wax, at least one anti-skinning agent, at least one defoamer, at least one fungicide, at least one biocide, at least one mildewcide, at least one thickener, at least one UV stabilizer, or combinations thereof.

In many embodiments, the coating composition described herein is a wood stain. In one embodiment, the coating composition described herein is a semi-transparent wood stain or semi-solid wood stain. In one embodiment, the coating composition described herein is a solid color wood stain. In another embodiment, the coating composition described herein is a clear coat. In other embodiments, the coating composition described herein is a primer. In yet other embodiments, the coating composition described herein is a basecoat. In some other embodiments, the coating composition described herein is a topcoat.

Also described herein is a method of preparing the coating described herein comprising at least one non-aqueous dispersion (NAD) acrylic alkyd polymer, at least one non-aqueous dispersion (NAD) acrylic polymer, or combinations thereof and at least one siloxane.

Further described is a method of at least partially applying the coating composition described herein to at least one substrate. In many embodiments, at least one substrate is wood, metal, glass, plastic, paper,-leather, fabric, ceramic, concrete, composites, or combinations thereof. The wood may include pine (including southern yellow pine), cedar, redwood, teak, ipe, oak, douglas fir, tigerwood, garapa, mahogany, Manilkara bidentata (also known as bulletwood), and other woods suitable for decking. Additionally, the wood may be pressure treated with various chemicals to protect the wood from structural degradation as well as termites and other wood-destroying insects, mold, decaying fungi, marine conditions, and flames. These chemicals for pressure treatments may include but are not limited to alkaline copper quat (ACQ) and micronized versions thereof, ammonium copper zine arsenate (ACZA), ammoniacal copper arsenate (ACA), chromated copper arsenate (CCA) and micronized versions thereof, acid copper chromate (ACC), copper-HDO (bis-(n-cyclohexyldiazeniumdioxy-copper)), propiconazole, isothiazolinones, triadimefon, copper napthanate, copper azoles, polymeric betaine, borates, pentachlorophenol, creosote, or combinations thereof. Other chemicals for pressure treatment are also contemplated. In one embodiment, at least one substrate is a previously coated substrate. In many embodiments, at least partially applying the coating may be achieved by brush, roller, spray (air atomized, airless, high-volume low pressure (HVLP), and electrostatic), pad, dip coating, roll coating, spin coating, flow coating, curtain coating, centrifugal coating, continuous coating, and autodeposition. Other application methods are also contemplated.

In many embodiments, an article comprising the coating composition described herein is also disclosed. In some embodiments, an article may comprise: 1) a substrate having at least one surface; and 2) the coating composition described herein. In some embodiments, the substrate is wood, metal, glass, plastic, paper,-leather, fabric, ceramic, concrete, composites, or combinations thereof. In other embodiments, the substrate is a previously coated substrate. The previously coated substrate may be a substrate that is covered by a waterborne coating or a solvent-based coating. In many embodiments, the previously coated substrate comprises one coating. In yet another embodiment, the previously coated substrate comprises at least one additional coating. In many embodiments, at least one additional coating may comprise a solvent borne or a waterborne coating. In one embodiment, at least one additional coating may be different from the coating composition described herein. In another embodiment, at least one additional coating may be the same as the coating composition described herein.

### Experimental Results

The following samples were prepared in Table 1 below with results as provided.

TABLE 1
Stain Formulas and Test Results

| | Formulation (by weight) | | | | | |
|---|---|---|---|---|---|---|
| | | | | | | Sample 5 - |
| | | | Sample 2 - | Sample 3 - | Sample 4 - | replacing |
| | | | replacing some | replacing some | replacing | traditional |
| | | | traditional | traditional | traditional | HS alkyd |
| | | | HS alkyd resin | HS alkyd resin | HS alkyd | resin with |
| | | Sample 1 - | with NAD | with NAD | resin with | NAD resin + |
| | CONTROL | adding VMS | resin | resin + VMS | NAD resin | VMS |
| MINERAL SPIRITS | 31.5 | 21.5 | 28.5 | 18.5 | 22.4 | 12.4 |
| MINERAL OIL | 8.0 | 8.0 | 8.0 | 8.0 | 8.0 | 8.0 |
| Suspension agent | 1.0 | 1.0 | 1.0 | 1.0 | 1.0 | 1.0 |
| PARAFFIN WAX | 1.7 | 1.7 | 1.7 | 1.7 | 1.7 | 1.7 |
| NAD alkyd resin | | | 20.0 | 20.0 | 60.6 | 60.6 |
| Traditional HS alkyd resin | 51.5 | 51.5 | 34.5 | 34.5 | | |
| VMS | | 10.0 | | 10.0 | | 10.0 |
| UV Absorber | 0.9 | 0.9 | 0.9 | 0.9 | 0.9 | 0.9 |
| Fungicide | 2.0 | 2.0 | 2.0 | 2.0 | 2.0 | 2.0 |
| Colorant | 1.6 | 1.6 | 1.6 | 1.6 | 1.6 | 1.6 |
| Primary Driers | 0.7 | 0.7 | 0.7 | 0.7 | 0.7 | 0.7 |
| Secondary Driers | 0.9 | 0.9 | 0.9 | 0.9 | 0.9 | 0.9 |
| Anti-skin agent | 0.2 | 0.2 | 0.2 | 0.2 | 0.2 | 0.2 |
| Total Weight | 100.0 | 100.0 | 100.0 | 100.0 | 100.0 | 100.0 |
| Properties | | | | | | |
| Calculated VOC | 323 | 238 | 325.49 | 231.5 | 331 | 240 |
| Weight per Gallon | 7.52 | 7.69 | 7.69 | 7.87 | 8.05 | 8.24 |
| Viscosity. | 42 | 52 | 41 | 55 | 38 | 50 |
| Tack Free @ uncoated | NO | NO | NO | NO | YES | YES |
| Leneta Card @ 3 hrs | | | | | | |
| Tack Free @ Coated | NO | NO | YES | YES | YES | YES |
| Leneta Card @ 24 hrs | | | | | | |
| Gloss @ 60°, Coated | 91 | 91 | 91 | 91 | 91 | 91 |
| Leneta Card @ 24 hrs | | | | | | |
| Gloss @ 60°, Uncoated | 91 | 91 | 91 | 91 | 32 | 32 |
| Leneta Card @ 24 hrs | | | | | | |

Several samples were prepared in which a traditional high solids (HS) alkyd resin (in the Control formula) was evaluated against other formulas in which the NAD alkyd acrylic polymer and at least one siloxane were added at various levels (Samples 1-4). In Sample 5, the traditional high solids (HS) alkyd resin was completely replaced by the NAD alkyd acrylic polymer and at least one siloxane.

For testing, Volatile Organic Compound (VOC) was measured using EPA M24 and reported in grams per liter. Weight per gallon was measured using ASTM D1475 and reported in pounds per gallon. Viscosity was measured using ASTM D562 and reported in Krebs units (KU). For tack-free measurements on Leneta charts (plain white both sealed and unsealed sides), the coatings were applied on the Leneta chart and tested at their respective time intervals. Gloss at 60° was measured using ASTM D523.

From Table 1, replacing the traditional high solids (HS) alkyd resin (Control) with NAD alkyd acrylic polymer and volatile methyl siloxane (also referred to as VMS) (Sample 5) provides a lower calculated VOC (in grams per liter). Further, the calculated VOC of the NAD alkyd acrylic polymer and VMS (Sample 5) is also less than those samples either replacing either some (Sample 2) or all (Sample 4) of the traditional high solids (HS) alkyd resin with NAD. Additionally, using the NAD alkyd acrylic polymer and VMS (Sample 5) provides an improved tack free result over the traditional high solids (HS) alkyd resin (Control) and partial replacements of the traditional high solids (HS) alkyd resin (Control) with NAD alkyd acrylic polymer (Samples 2 and 3). Also, the viscosity is acceptable for the NAD alkyd acrylic polymer and VMS (Sample 5).

### Embodiments

The following embodiments are contemplated. All combinations of features and embodiments are contemplated.
Embodiment 1: A coating composition, comprising: at least one non-aqueous dispersion (NAD) acrylic alkyd polymer, at least one non-aqueous dispersion (NAD) acrylic polymer, or combinations thereof; and at least one siloxane.
Embodiment 2: An embodiment of Embodiment 1, wherein about 10% to 99.5% by weight of the coating composition comprises the at least one non-aqueous dispersion (NAD) acrylic alkyd polymer, at least one non-aqueous dispersion (NAD) acrylic polymer, or combinations thereof.
Embodiment 3: An embodiment of any of Embodiments 1-2, wherein the non-aqueous dispersion (NAD) acrylic alkyd polymer, at least one non-aqueous dispersion (NAD) acrylic polymer, or combinations thereof comprises at least one acrylic has a glass transition temperature (Tg) of 20° C. to 60° C. as measured by Differential Scanning calorimetry (DSC) using ASTM D6604-00.
Embodiment 4: An embodiment of any of Embodiments 1-3, wherein about 0.5% to about 20% by weight of the coating composition comprises the at least one siloxane.
Embodiment 5: An embodiment of any of Embodiments 1-4, wherein the at least one siloxane is cyclic, linear, or combinations thereof.
Embodiment 6: An embodiment of any of Embodiments 1-5, wherein the at least one siloxane is methyl siloxane.
Embodiment 7: An embodiment of Embodiment 6, wherein the methyl siloxane comprises cyclotetrasiloxane, cyclopentasiloxane cyclohexasiloxane, octamethylcyclotetrasiloxane, decamethylcyclopentasiloxane, dodecamethylcyclohexasiloxane, trisiloxane, dimethicone, or combinations thereof.
Embodiment 8: An embodiment of any of Embodiments 1-7 further comprising at least one hyper-branched alkyd polymer.
Embodiment 9: An embodiment of Embodiment 8, wherein about 0% to about 20% by weight of the coating composition comprises the at least one hyper-branched alkyd polymer.
Embodiment 10: An embodiment of any of Embodiments 8-9, wherein the at least one hyper-branched alkyd polymer is obtained by reacting at least one fatty acid with at least one hyper-branched polyol.
Embodiment 11: An embodiment of any of Embodiments 8-10, wherein the at least one hyper-branched polyol comprises at least one polyester.
Embodiment 12: An embodiment of any of Embodiments 1-11 further comprising at least one alkyd resin.
Embodiment 13: An embodiment of Embodiment 12, wherein about 10% to about 40% by weight of the coating composition comprises the at least one alkyd resin.
Embodiment 14: An embodiment of any of Embodiments 1-13, wherein the coating composition further comprises at least one reactive diluent, at least one non-reactive diluent, at least one solvent, at least one drier, at least one colorant, at least one pigment, at least one dispersant, at least one surfactant, at least one wax, at least one anti-skinning agent, at least one defoamer, at least one fungicide, at least one biocide, at least one mildewcide, at least one thickener, at least one UV stabilizer, or combinations thereof.
Embodiment 15: An embodiment of any of Embodiments 1-14, wherein the coating composition is a wood stain.
Embodiment 16: An embodiment of any of Embodiments 1-15, wherein the coating composition has a volatile organic compound content of less than about 250 g/L according to EPA M24.
Embodiment 17: A method of preparing the coating composition of any of Embodiments 1-16.
Embodiment 18: A method of at least partially applying the coating composition of any of Embodiments 1-16 to at least one substrate.
Embodiment 19: An embodiment of Embodiment 18, wherein at least one substrate is wood, metal, glass, plastic, paper, leather, fabric, ceramic, concrete, composites, or combinations thereof.
Embodiment 20: An embodiment of Embodiment 18, wherein at least one substrate is a previously coated substrate.
Embodiment 21: An article comprising the coating composition of any of Embodiments 1-16.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A coating composition, comprising:
at least one non-aqueous dispersion (NAD) acrylic alkyd polymer, at least one non-aqueous dispersion (NAD) acrylic alkyd polymer, or combinations thereof; and
at least one siloxane.

2. The coating composition of claim 1, wherein about 10% to 99.5% by weight of the coating composition comprises the at least one non-aqueous dispersion (NAD) acrylic alkyd polymer, at least one non-aqueous dispersion (NAD) acrylic alkyd polymer, or combinations thereof.

3. The coating composition of any of claims 1-2, wherein the non-aqueous dispersion (NAD) acrylic alkyd polymer, at least one non-aqueous dispersion (NAD) acrylic alkyd polymer, or combinations thereof comprises at least one acrylic has a glass transition temperature (Tg) of 20° C. to 60° C. as measured by Differential Scanning calorimetry (DSC) using ASTM D6604-00.

4. The coating composition of any of claims 1-3, wherein about 0.5% to about 20% by weight of the coating composition comprises the at least one siloxane.

5. The coating composition of any of claims 1-4, wherein the at least one siloxane is cyclic, linear, or combinations thereof.

6. The coating composition of any of claims 1-5, wherein the at least one siloxane is methyl siloxane.

7. The coating composition of claim 6, wherein the methyl siloxane comprises cyclotetrasiloxane, cyclopentasiloxane cyclohexasiloxane, octamethylcyclotetrasiloxane, decamethylcyclopentasiloxane, dodecamethylcyclohexasiloxane, trisiloxane, dimethicone, or combinations thereof.

8. The coating composition of any of claims 1-7, further comprising at least one hyper-branched alkyd polymer.

9. The coating composition of claim 8, wherein about 0% to about 20% by weight of the coating composition comprises the at least one hyper-branched alkyd polymer.

10. The coating composition of any of claims 8-9, wherein the at least one hyper-branched alkyd polymer is obtained by reacting at least one fatty acid with at least one hyper-branched polyol.

11. The coating composition of any of claims 8-10, wherein the at least one hyper-branched polyol comprises at least one polyester.

12. The coating composition of any of claims 1-11 further comprising at least one alkyd resin.

13. The coating composition of claim 12, wherein about 10% to about 40% by weight of the coating composition comprises the at least one alkyd resin.

14. The coating composition of any of claims 1-13, wherein the coating composition further comprises at least one reactive diluent, at least one non-reactive diluent, at least one solvent, at least one drier, at least one colorant, at least one pigment, at least one dispersant, at least one surfactant, at least one wax, at least one anti-skinning agent, at least one defoamer, at least one fungicide, at least one biocide, at least one mildewcide, at least one thickener, at least one UV stabilizer, or combinations thereof.

15. The coating composition of any of claims 1-14, wherein the coating composition is a wood stain.

16. The coating composition of any of claims 1-15, wherein the coating composition has a volatile organic compound content of less than about 250 g/L according to EPA M24.

17. A method of preparing the coating composition of any of claims 1-16.

18. A method of at least partially applying the coating composition of any of claims 1-16 to at least one substrate.

19. The method of claim 18, wherein at least one substrate is wood, metal, glass, plastic, paper, leather, fabric, ceramic, concrete, composites, or combinations thereof.

20. The method of claim 18, wherein at least one substrate is a previously coated substrate.

21. An article comprising the coating composition of any of claims 1-16.
